(19) United States
(12) Patent Application Publication
(10) Pub. No.: US 2026/0019435 A1
(43) Pub. Date: Jan. 15, 2026

(54) STREAM-ADAPTABLE REGULARIZATION FOR MODELS

(71) Applicant: Capital One Services, LLC, McLean, VA (US)

(72) Inventors: Samuel SHARPE, Cambridge, MA (US); Christopher Bayan BRUSS, Washington, DC (US)

(73) Assignee: Capital One Services, LLC, McLean, VA (US)

(21) Appl. No.: 18/772,021

(22) Filed: Jul. 12, 2024

(51) Int. Cl. H04L 9/40

(52) U.S. Cl. CPC H04L 63/1425; H04L 63/1416

(57) ABSTRACT

In some embodiments, a method and related system for creating a steam-adaptable encoder model includes generating a first complete encoded representation using the encoder model based on unrestricted data provided by a first unrestricted data stream and restricted data provided by a restricted data stream. The method also includes generating an unrestricted encoded representation based on the first unrestricted data, evaluating a loss function value by updating the loss function value based on a similarity between the first complete encoded representation and the unrestricted encoded representation, and updating the encoder model based on the loss function value. The method also includes updating the encoder model based on the loss function value, generating an encoded representation using the encoder model based on filtered data that includes additional data from the first unrestricted data stream, and generating an indicator based on the encoded representation.

### SUMMARY

In many cases, machine learning models can be made to respond to events in real time. By responding to real-time events, malicious activity such as fraudulent activity or deceptive activity can be detected and prevented from occurring. In addition, other user activities may be predicted to create personalized changes to a user interface (UI) or retrieve data useful for an operation in anticipation of a user's future likelihood of performing that operation.

Despite the hypothetical protections offered by machine learning models when responding to real-time events, however, both technical and policy-based limitations can reduce the effectiveness of such protections. For example, a machine learning model used to categorize a user action or predict about a future action may often be trained on data from multiple event data streams or other types of data streams. However, if these event data streams are unavailable due to a technical error or a policy-based restriction on use (e.g., a restriction on using web activity tracking data), then any downstream predictions based on that information could be incorrectly skewed as a result of a built-in assumption that such data streams are available. These limitations can be exacerbated when such data streams are used to generate encoded representations that are then used for downstream operations.

Some embodiments may overcome the technical issue described above by performing a set of training operations with certain terms in the training loss function designed to regularize a machine learning model with respect to different data streams. This loss function includes terms that will increase a loss function value when the outputs derived from a complete collection of data streams for a first user are dissimilar from the outputs derived from only the unrestricted data streams for that user. Furthermore, to prevent the loss function from merely providing the same output for all inputs, the loss function includes at least one term that will increase a loss function value when the outputs derived from the complete collection of data streams for the first user are similar to outputs derived from the data streams of other users.

For example, some embodiments may generate a complete dense vector (or other type of encoded representation) for a first user by inputting both first unrestricted event stream data and restricted event stream data into an encoder model. Some embodiments may then generate a second complete dense vector corresponding with a second user that will be used to contribute to a loss function. Some embodiments may generate this second complete dense vector by inputting second unrestricted event stream data corresponding with the behavior and activity associated with this second user into the encoder model. Additionally, some embodiments may generate an unrestricted dense vector by providing only the unrestricted data to the encoder model without providing the restricted data into the encoder model. Some embodiments may then evaluate a loss function value using a first term that increases the loss function value based on a similarity between the first complete dense vector and the unrestricted dense vector and a second term that decreases the loss function value based on a similarity between the first complete dense vector and the second complete dense vector. Some embodiments may then backpropagate or otherwise train the weights or other model parameters of the encoder model based on the loss function value.

After training the encoder model, some embodiments may then use the encoder model to generate a library of user referenced vectors for downstream use. Alternatively, or additionally, some embodiments may use the encoder model in real-time operations by updating a user's event stream with new events caused by or otherwise associated with the user. Some embodiments may then provide the updated event stream to the trained encoder model. The output of the trained encoder model may act as a candidate reference vector that is mapped to the user.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates a system for regularizing a machine learning model with respect to different data streams, in accordance with some embodiments.

FIG. 2 illustrates a conceptual diagram of encoder model regularization with respect to different data streams, in accordance with some embodiments.

FIG. 3 is a flowchart of a process for regularizing an encoder model, in accordance with some embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

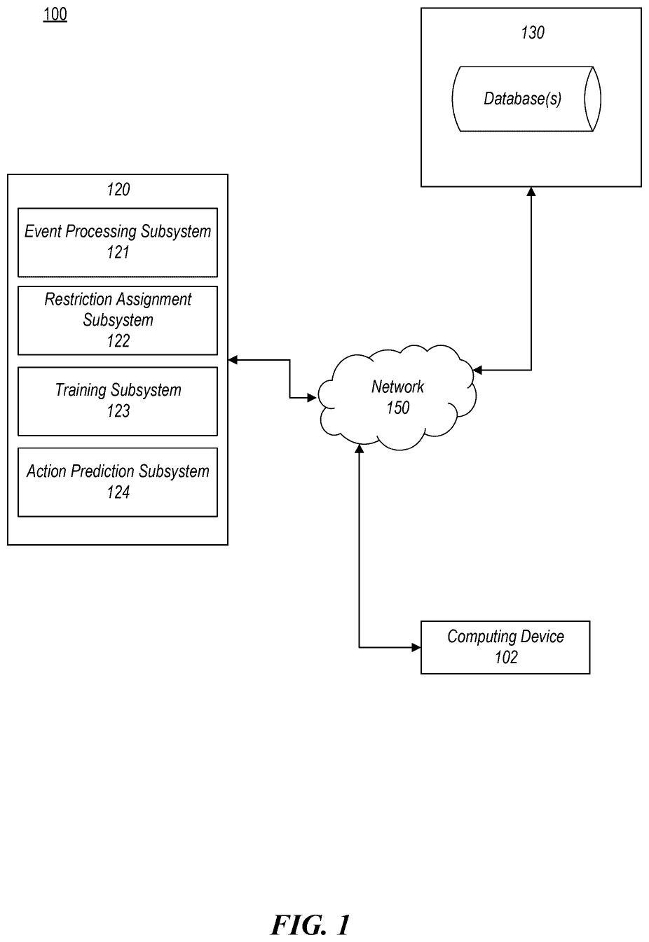

FIG. 1 illustrates a system for regularizing a machine learning model with respect to different data streams, in accordance with some embodiments. The system 100 includes a computing device 102. The computing device 102 may include computing devices such as a desktop computer, a laptop computer, a wearable headset, a smartwatch, another type of mobile computing device, a transaction device, etc. In some embodiments, the computing device 102 may communicate with various other computing devices via a network 150, where the network 150 may include the internet, a local area network, a peer-to-peer network, etc. The computing device 102 may send and receive messages through the network 150 to communicate with a first set of servers 120 within a first data center region, where the first set of servers 120 may include a set of non-transitory storage media storing program instructions to perform one or more operations of subsystems 121-124.

While one or more operations are described herein as being performed by particular components of the system 100, those operations may be performed by other components of the system 100 in some embodiments. For example, one or more operations described in this disclosure as being performed by the first set of servers 120 may instead be performed by the computing device 102. Furthermore, some embodiments may communicate with an application programming interface (API) of a third-party service via the network 150 to perform various operations disclosed herein. For example, some embodiments may provide training data for an encoder model to an API of a service, where the service may respond with a trained encoder model that was trained with the training data.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure. For example, the set of databases 130 may store event stream data, other data stream data, etc.

In some embodiments, an event processing subsystem 121 may obtain event data or other data from one or more data streams. The event processing subsystem 121 may obtain data from multiple data streams, such as sensor data from one or more sensors (e.g., temperature readings, pressure readings, etc.), clickstream data from a website or web application, application data from another type of application, financial transaction data, application log data, etc. For example, some embodiments may obtain first event data from a first event stream representing user interaction data with an application UI, second event stream data representing financial transaction data indicating user purchases using a first credit card associated with a first organization, financial transaction data indicating user purchases using a second credit card associated with a different organization, and user account data indicating configuration changes or user profile changes for the user. The event data may be structured as JavaScript object notation (JSON) data, extensible markup language (XML) data, protobuf data, Avro data, CSV data, text-based log data, or application-specific custom formats.

The event processing subsystem 121 may perform pre-processing steps to modify incoming event data or other data. In some embodiments the event processing subsystem 121 may normalize event values (e.g., normalize all values with respect to a maximum value), add or subtract a constant to one or more values, multiply one or more values of an event by a pre-determined factor, etc. Alternatively, or additionally, some embodiments may determine whether a value satisfies one or more criteria and modify the value or replace the value based on the satisfaction or non-satisfaction of the one or more criteria. For example, some embodiments may determine whether an event value of a transaction event is greater or lesser than “100.” In response to a determination that the event value is greater than or equal to “100,” some embodiments may change the value to indicate that the event value was greater than or equal to 100 (e.g., by using “1” as an indicator value and updating an event record to store this indicator value). Alternatively, if the event value is not greater than or equal to 100, some embodiments may change the value to indicate that this criterion was not satisfied (e.g., by using “0” as an indicator value). In some embodiments, the event processing subsystem 121 may generate additional data from event values of an event to associate with the event. For example, after receiving event data indicating a transaction event, some embodiments may use a transaction amount indicated by the event data and determine a running total by adding the transaction amount to a running total associated with one or more merchant identifiers indicated by the event data. Some embodiments may then update the event data with the updated running total for further use.

In some embodiments, a restriction assignment subsystem 122 may determine what event data is restricted with respect to downstream operations or applications. In some embodiments, the restriction assignment subsystem 122 may select entire data streams for assignment as restricted data streams. For example, some embodiments may assign a set of event streams for third-party credit card transactions as part of a set of restricted data streams. Alternatively, or additionally, the restriction assignment subsystem 122 may determine that clickstream data from a clickstream-related event stream associated with a set of websites or web applications are restricted. Furthermore, the restriction assignment subsystem 122 may select restrictions based on a target downstream operation. For example, some embodiments may receive clickstream data from a clickstream event stream, transaction data associated with a first financial transaction card, and user account data. The restriction assignment subsystem 122 may restrict the clickstream data for public operations related to predictive advertising while not restricting the clickstream data for malicious activity detection (e.g., detecting that a user account has been hacked, that a user account is being used to access unauthorized data, etc.).

In some embodiments, the training subsystem 123 may perform operations described in this disclosure to train an encoder model to generate regularized encoder models that are regularized with respect to different combinations of data streams. For example, the training subsystem 123 may first determine a set of different encoded representations, where an encoded representation may include a vector (e.g., a dense vector having at least 10 non-zero elements), a matrix, a tensor, a graph, an unordered set of values, etc. In some embodiments, the encoder model may include one or more types of encoders, such as an autoencoder, variational autoencoder (VAE), convolutional neural network (CNN), recurrent neural network (RNN), transformer neural network, etc.

The training subsystem 123 may use one of various types of loss functions that are affected by similarities between different outputs of an encoder model (i.e., similarities between different encoded representations). To generate these different outputs, some embodiments may change the inputs provided to the encoder model. The training subsystem 123 may first generate a complete encoded representation (e.g., a complete dense vector) by inputting into an encoder model a first collection of data provided by both restricted data streams and unrestricted data streams. For example, the training subsystem 123 may provide a first amount of collected data from a transaction event stream indicating multiple transaction events and values associated with those transaction events and a clickstream event stream, indicating different user interactions with a web application. Some embodiments may determine that the clickstream event stream is a restricted data stream and that the transaction event stream is an unrestricted event stream. The encoder model may then produce a first complete dense vector based on the first amount of collected data. The training subsystem 123 may further input the portion of the first collected data that was provided by the unrestricted data stream (e.g., the transaction event stream) into the encoder model in order to obtain an unrestricted encoded representation. Some embodiments may then determine a similarity between the two encoded representations as a first modifier to a loss function value to act as a contrastive loss between the two encoded representations.

The training subsystem 123 may determine a second modifier for the loss function value based on a similarity between the encoded representation for a first user and a set of encoded representations associated with a second user. For example, after determining a first complete encoded representation for a first user using the operations described above, some embodiments may obtain a second complete encoded representation by inputting, into the encoder model, a second amount of collected data from another transaction event stream for events related to a second user. Some embodiments may then determine a difference between the first and second complete encoded representations to determine a second modifier to the loss function value. To determine which other user to use as a second user for this operation, some embodiments may randomly select users as the second user. Alternatively, or additionally, some embodiments may use a rule-based system to select other users who share a demographic category with the first user.

Furthermore, training subsystem 123 may determine an additional modifier for the loss function based on a similarity between the encoded representation for the first user and one or more encoded representations for other users derived from the unrestricted data streams of the other users. For example, after determining the first complete encoded representation for the first user using the encoder model, some embodiments may then determine one or more unrestricted encoded representations by providing the encoder model with unrestricted event stream data associated with a second user without providing restricted event stream data to the encoder model. Some embodiments may then determine a similarity between the complete encoded representation associated with the first user and the unrestricted encoded representation associated with the second user to determine another modifier to the loss function value.

Some embodiments may combine the modifiers described above into a single loss function. Some embodiments may then use this loss function to determine, for a first user, a set of loss function values for other users for each neighboring loss function. Some embodiments may then determine a final loss function value. For example, some embodiments may determine a similarity between two dense vectors using a cosine similarity score between the two dense vectors. For example, some embodiments may represent a loss function value “L” with Equation 1, where λ₁ is a first factor weight, and where λ₂ is a second factor weight, and where Oe₁ represents a complete encoded representation associated with a first user, and where De₁ represents a first unrestricted encoded representation associated with the first user, and where Oe₂ represents a second unrestricted encoded representation associated with a second user, and where De₂ represents a first unrestricted encoded representation associated with the second user, and where “Sim” is a similarity operator (e.g., a cosine similarity operator):

$$L = S i m ( O {e}_{1} , {De}_{1} ) - {λ}_{1} S i m ( O {e}_{1} , O {e}_{2} ) - {λ}_{2} Sim ( O {e}_{1} , {De}_{2} ) \qquad Eq . 1$$

Some embodiments may then repeat the training operation and recalculate new loss function values using the operations described above until the final loss function value for an iteration satisfies one or more loss function criteria. For example, some embodiments may require that a loss function value is less than or equal to a loss function threshold. Alternatively, or additionally, some embodiments may be configured to determine that a terminal iteration has been reached when a change in loss function values is less than a threshold.

As described elsewhere in this disclosure, by using an encoder model to capture granular events in the context in which they occur when generating an encoded representation, some embodiments may increase the predictive power in characterization power of the encoded representation. However, capturing the full context of a user's behavior and events related to the user may be technically impossible, technically onerous, or non-permitted as a result of regulatory limitations or other legal hurdles. Some embodiments may help overcome these hurdles by using a loss function and related training operation that generates an encoder model adaptable for multiple combinations of data streams without requiring that the system trade different encoder models for different combinations of incoming data streams.

Some embodiments may use an action prediction subsystem 124 in order to determine or predict a user behavior. For example, some embodiments may detect malicious activity associated with a user account by using an encoder model described in this disclosure to generate an encoded representation of a user based on an event history for the user. Some embodiments may then use the encoded representation as an input for a downstream prediction model, where the downstream production model may then output a likelihood indicating that the user was engaging in malicious activities or that the user is a victim of malicious activities.

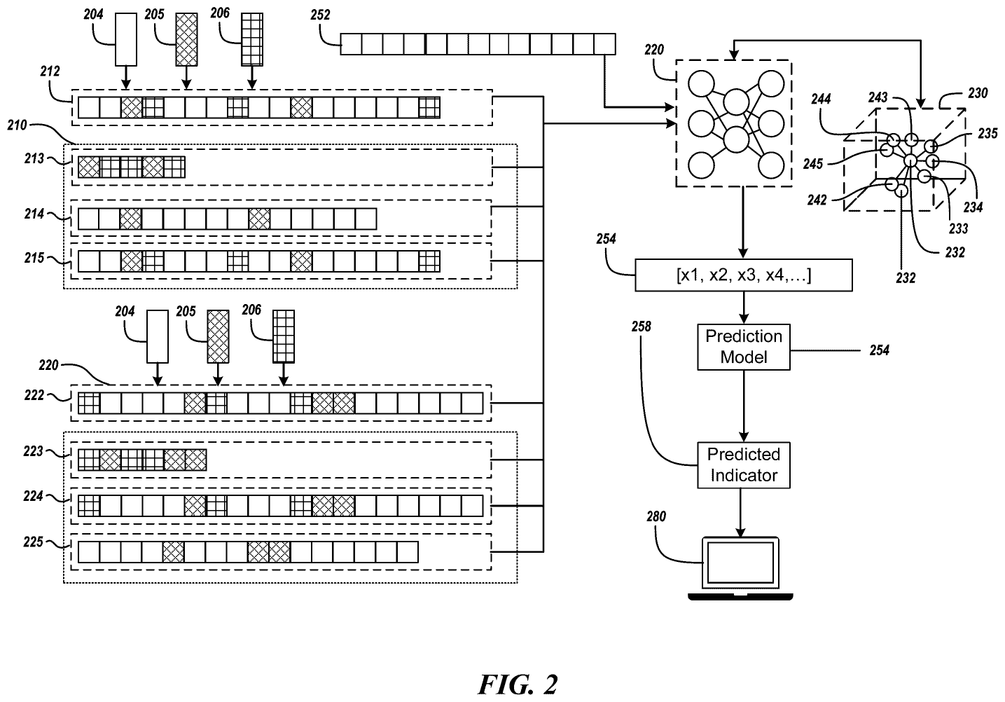

FIG. 2 illustrates a conceptual diagram of encoder model regularization with respect to different data streams, in accordance with some embodiments. Some embodiments may obtain data from different data streams, including a first data stream 204, a second data stream 205, and a third data stream 206. Some embodiments may then use the data from the data streams 204-206 corresponding with a first user to form an event sequence 212 that will be used as an input for an encoder model 220 to generate a first complete encoded representation 232 in a latent space 230. In some embodiments, there may be multiple complete encoded representations 232. Some embodiments may use the similarity between the first complete encoded representation 232 and other vectors in the latent space 230 to train the encoder model 220 such that the encoder model 220 becomes more invariant to which data stream of the data streams 204-206 is used.

To determine some of the additional vectors in the latent space 230 used to train the encoder model 220, some embodiments may use the event sequence 212 to generate additional inputs for the encoder model 220. Some embodiments may then generate multiple other partial event sequences by treating each of the data streams 204-206 as restricted datasets. For example, some embodiments may remove data in the event sequence 212 from the first data stream 204 to generate a first unrestricted event sequence 213, remove data from the first data stream 204 corresponding with the second data stream 205 to generate a second unrestricted event sequence 214, and remove the data from the first data stream 204 corresponding with the third data stream 206 to generate a third unrestricted event sequence 215, as illustrated in box 210. It should be understood that the removal of data from the first data stream 204 may include ensuring that the order of the data is preserved. For example, the sequence of events represented by the first unrestricted event sequence 213 may remain in chronological order.

In some embodiments, data from the data streams 204-206 corresponding with a second user may be collected into an event sequence 222 that will be used as an input for the encoder model 220 to generate a second complete encoded representation 242 in the latent space 230. As described elsewhere in this disclosure, the second complete encoded representation 242 may be one of the additional vectors in the encoder model 220 used to contrast with the first complete encoded representation 232 to help with training the encoder model 220. Some embodiments may then generate multiple other partial event sequences associated with the first user by treating each of the data streams 204-206 as restricted datasets. For example, some embodiments may remove data from the first data stream 204 to generate a fourth unrestricted event sequence 223, remove data from the first data stream 204 corresponding with the second data stream 205 to generate a fifth unrestricted event sequence 224, and remove the data from the first data stream 204 corresponding with the third data stream 206 to generate a sixth unrestricted event sequence 225.

As described elsewhere in this disclosure, some embodiments may provide the event sequence 212 to the encoder model 220 to generate the first complete encoded representation 232 and update the encoder model 220 based on contrastive loss terms between the first complete encoded representation 232 and other vectors in the latent space 230. Some embodiments may provide the first unrestricted event sequence 213 to the encoder model 220 to generate a first unrestricted encoded representation 233. Some embodiments may provide the second unrestricted event sequence 214 to the encoder model 220 to generate a second unrestricted encoded representation 234. Some embodiments may provide the third unrestricted event sequence 215 to the encoder model 220 to generate a third unrestricted encoded representation 235. Some embodiments may provide the event sequence 222 to the encoder model 220 to generate the second complete encoded representation 242. Some embodiments may provide the fourth unrestricted event sequence 223 to the encoder model 220 to generate a fourth unrestricted encoded representation 243. Some embodiments may provide the fifth unrestricted event sequence 224 to the encoder model 220 to generate a fifth unrestricted encoded representation 244. Some embodiments may provide the sixth unrestricted event sequence 225 to the encoder model 220 to generate a sixth unrestricted encoded representation 245.

When training the encoder model 220, some embodiments may compute similarity scores between the first complete encoded representation 232 and each of the other encoded representations 233-235 and 242-245. Some embodiments may then determine a maximum from different subsets of similarity scores to determine a final loss function value. For example, some embodiments may determine a loss function value “L” using Equation 2, where “Sim” is a similarity function, and where λ₁₁ is a first factor weight, and where λ₁₂ is a second factor weight, and where λ₁₃ is a third factor weight, and where λ₂₁ is a fourth factor weight, and where λ₂₂ is a fifth factor weight, and where λ₂₃ is a sixth factor weight, and where λ₂₄ is a seventh factor weight, and where e₂₃₂ is the vector representing the first complete encoded representation 232, and where e₂₃₃ is the vector representing the first unrestricted encoded representation 233, and where e₂₃₄ is the vector representing the second unrestricted encoded representation 234, and where e₂₃₅ is the vector representing the third unrestricted encoded representation 235, and where e₂₄₂ is the vector representing the second complete encoded representation 242, and where e₂₄₃ is the vector representing the fourth unrestricted encoded representation 243, and where e₂₄ is the vector representing the fifth unrestricted encoded representation 244, and where e₂₄₅ is the vector representing the sixth unrestricted encoded representation 245:

$$L = {λ}_{11} S i m ( {e}_{232} , {e}_{233} ) + {λ}_{12} S i m ( {e}_{232} , {e}_{234} ) + {λ}_{13} S i m ( {e}_{232} , {e}_{235} ) - {λ}_{21} S i m ( {e}_{232} , {e}_{242} ) - {λ}_{22} S i m ( {e}_{232} , {e}_{243} ) - {λ}_{23} S i m ( {e}_{232} , {e}_{244} ) - {λ}_{24} Sim ( {e}_{232} , {e}_{245} ) \qquad Eq . 2$$

As a part of training the encoder model 220, some embodiments may use backpropagation to update the weights or other parameters of the encoder model 220 based on the loss function value, where backpropagation is structured to increase the value of a future loss function value L. Some embodiments may then use the updated version of the encoder model 220 to the generate updated encoded representations, determine the new loss function value using Equation 2 or another loss function based on the updated encoded representations, and update the encoder model 220 again using the new loss function value. Some embodiments may then repeat this process until a set of training termination criteria is satisfied (e.g., a change in the loss function value between one or more iterations is less than a threshold, the loss function value is less than a threshold, etc.).

Some embodiments may modify one or more of the factor weights used in Equation 2 to determine what similarities are prioritized. For example, some embodiments may decrease the values of λ₂₁, λ₂₂ and λ₂₃ based on a set of user instructions or parameter tuning operations. By decreasing λ₂₁, λ₂₂, and λ₂₃, some embodiments may decrease the contrastive loss contribution associated with differences between a first user's complete encoded representation and the second user's set of unrestricted encoded representations (i.e., fourth unrestricted encoded representation 243, fifth unrestricted encoded representation 244, and sixth unrestricted encoded representation 245).

After the encoder model 220 is trained, some embodiments may then provide filtered event stream data 252 to the encoder model 220 to generate the candidate encoded representation 254. It should be understood that while the encoder model 220 is shown as producing dense vector representations such as the candidate encoded representation 254, other encoder models may generate other types of encoded representations. Some embodiments may then provide the candidate encoded representation 254 to a prediction model 256 to generate a prediction indicator 258. Some embodiments may then send the prediction indicator 258 to a computing device 280 to perform one or more warning actions or other response actions (e.g., stopping one or more account changes, stopping one or more database transactions, etc.)

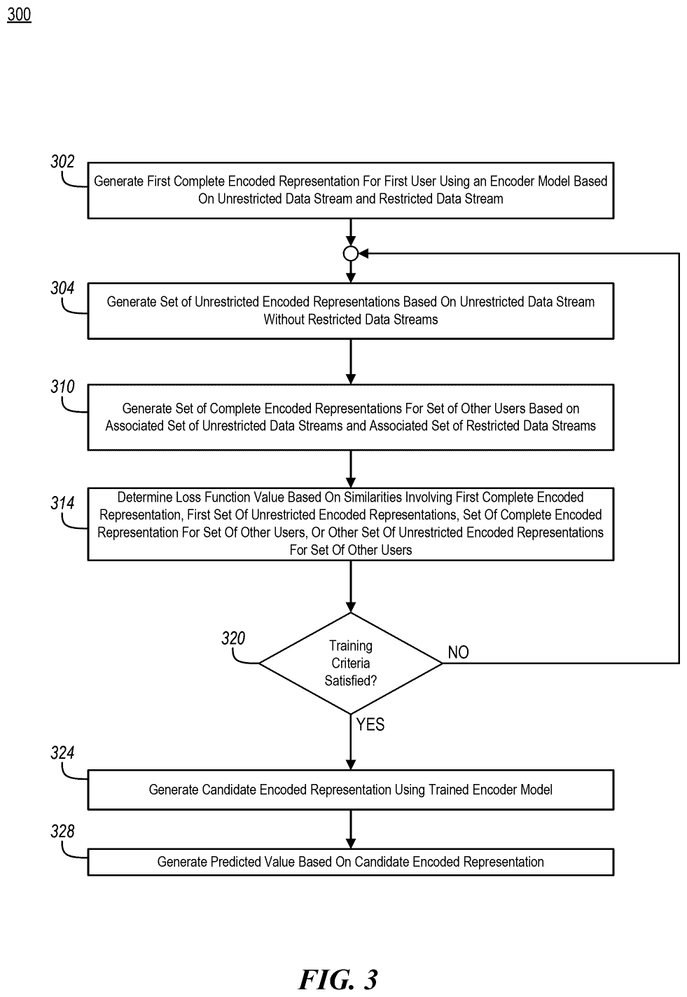

FIG. 3 is a flowchart of a process 300 for regularizing an encoder model, in accordance with some embodiments. Some embodiments may generate a first complete encoded representation for a first user using an encoder model based on an unrestricted data stream and a restricted data stream, as indicated by block 302. Some embodiments may obtain data from multiple data streams, such as data streams indicating events characterized by one or more values associated with the events. After obtaining the data from the multiple data streams, some embodiments may sort the data in chronological order to determine a data sequence associated with the plurality of data streams. Furthermore, some embodiments may perform operations to classify one or more candidate data streams as either being restricted or unrestricted for filtering purposes. For example, some embodiments may obtain a request that includes or is associated with an indicator of a request source (e.g., a user identifier of a user making the request). Some embodiments may then determine that, for an unrestricted dataset used to generate an unrestricted encoded representation, the unrestricted dataset should not include a value mapped to the indicator. Some embodiments may then determine that a candidate data stream includes the value and, in response, categorize the candidate data stream as a restricted data stream.

Alternatively, or additionally, some embodiments may perform other operations to classify data in the sequence as restricted or unrestricted, such as by classifying all event data satisfying a set of filter criteria as restricted data. The set of filter criteria may include various types of filters, such as a filter for a specific value, a filter for a target identifier, a filter for a threshold being satisfied, a filter for a detected match, etc. For example, some embodiments may perform operations to classify all event data including a target identifier as being restricted. In some embodiments, the identifier may be a third-party identifier that can be determined from a bank identification number (BIN) stored in a credit card transaction record. For example, some embodiments may obtain data from a plurality of event streams and detect the presence of a target identifier in at least one event of a candidate event stream, where the target identifier may be retrieved from a record, document, or other collection of information. In response to detecting the target identifier in the candidate event stream, some embodiments may categorize the candidate event stream as a restricted event stream. Alternatively, some embodiments may require that the majority of events of an event stream includes the target identifier before categorizing the event stream as a restricted event stream. Alternatively, some embodiments may require that all events of an event stream include the target identifier before categorizing the event stream as a restricted event stream. Furthermore, some embodiments may filter broader data from an unrestricted event stream when determining the unrestricted data for prediction operations.

Some embodiments may generate a first set of unrestricted encoded representations based on an unrestricted data stream without the restricted data streams, as indicated by block 304. Some embodiments may generate an input dataset for an encoder model that includes only data that has not been restricted. For example, some embodiments may first obtain an initial dataset that includes both restricted data provided by one or more restricted data streams and unrestricted data provided by one or more restricted data streams to form a complete dataset. Some embodiments may then form an unrestricted dataset by removing the restricted data from the complete dataset while leaving the unrestricted data in the dataset. Some embodiments may then use an encoder model to (1) generate a complete dense vector based on the complete dataset and (2) generate an unrestricted dense vector with the unrestricted dataset. It should be understood that, while some embodiments may generate an unrestricted dense vector, other embodiments may generate other types of unrestricted encoded representations based on the unrestricted dataset.

Some embodiments may account for the possibility of short use histories when generating encoded representations. For example, some embodiments may randomly slice or otherwise randomly select portions of unrestricted data or restricted data. In some embodiments, randomly selecting a portion of data from an event sequence may define a time range t₀ to t₁, where the time range may start at the earliest event indicated by the randomly selected portion and ends at the latest event indicated by the randomly selected portion. Alternatively, some embodiments may randomly select the time range t₀ to t₁ and, in response, retrieve a set of unrestricted data within this randomly determined time range from a set of data streams. Furthermore, after selecting portions of non-restricted data to use, some embodiments may similarly limit restricted data in the same randomly selected portion. For example, when determining restricted data to remove from consideration when generating unrestricted encoded representations, some embodiments may select the restricted data indicated to have occurred between the time range t₀ and t₁ described above.

Some embodiments may generate a set of complete encoded representations for a set of other users based on an associated set of unrestricted data streams or an associated set of restricted data streams, as indicated by block 310. In some embodiments, additional user data may include both unrestricted and restricted data. For example, when comparing a first user's full output with a second user's full output, some embodiments may use both unrestricted and restricted data streams for the second user. To do so, some embodiments may obtain restricted data provided by a restricted event stream of the other user. As described elsewhere, some embodiments may then input unrestricted data and the restricted data associated with the second user into the encoder model.

After generating an encoded representation, some embodiments may store the generated encoded representation in a dataset, database, or other data structure for later use. In some embodiments, the stored representation may be stored in association with a user and may be used to characterize one or more features of the user. Furthermore, some embodiments may store multiple versions of representations. For example, some embodiments may store both a complete encoded representation in association with a user and store an unrestricted encoded representation in association with the user. Furthermore, as described elsewhere in this disclosure, some embodiments may select a particular encoded representation based on a later-obtained request or information associated with the later-obtained request.

Some embodiments may store different models to generate different types of encoded representations for different datasets with different qualifiers for restricted data. For example, some embodiments may generate a first set of complete and unrestricted encoded representations based on a collection of data from multiple data streams when training a first version of the encoder model, where a first subset of data streams is classified as being restricted data streams. Some embodiments may also generate a second set of complete and unrestricted encoded representations based on the same collection of data, where a second subset of data streams is classified as restricted data when training a second version of the encoder model. Some embodiments may then store both versions of the encoder model in association with a user, a set of data streams, etc.

Some embodiments may determine a loss function based on similarities involving the first complete encoded representation, the first set of unrestricted encoded representations, the set of complete encoded representations for a set of other users, or a second set of unrestricted encoded representations for the set of other users, as indicated by block 314. As described elsewhere, some embodiments may generate a first complete encoded representation based on an initial set of data streams, generate a first set of unrestricted encoded representations based on a filtered version of the set of data streams, and then determine a first set of similarity scores between the first complete encoded representation and the first set of unrestricted encoded representations. In some embodiments, the loss function and downstream model updates (e.g., using stochastic gradient descent) may be configured to encourage greater similarity between the first complete encoded representation and the first set of unrestricted encoded representations. In such configurations, if lesser values of a first set of similarity scores indicate greater similarity between the first complete encoded representation and the first set of unrestricted encoded representations, then the model parameters of an encoder model should trend to decreasing the first set of similarity scores over multiple training iterations. For example, if a first similarity score indicates a distance in the latent space of the encoded representations between the first complete encoded representation and the first set of unrestricted encoded representations, the first similarity score should decrease over progressive training iterations.

Alternatively, or additionally, some embodiments may further generate one or more other complete encoded representations based on data stream data for other users and determine a second set of similarities between the first complete encoded representation and the one or more other set of complete encoded representations. In some embodiments, the loss function and downstream model updates may be configured to encourage less similarity between the first complete encoded representation and the first set of unrestricted encoded representations. In such configurations, if lesser values of a second set of similarity scores indicate greater similarity between the first complete encoded representation and the one or more other complete encoded representations, then the model parameters of an encoder model should trend to increasing the second set of similarity scores over multiple training iterations.

Furthermore, some embodiments may filter, from data streams for one or more other users, restricted data provided by a set restricted data streams and use the filtered data to generate a second set of unrestricted encoded representations for the one or more other users. Some embodiments may then determine a third set of similarities between the first complete encoded representation and the second set of unrestricted encoded representations. In some embodiments, the loss function and downstream model updates may be configured to encourage less similarity between the first complete encoded representation and the second set of unrestricted encoded representations. In such configurations, if decreases in a third set of similarity scores indicate greater similarity between the first complete encoded representation and the second set of unrestricted encoded representations, then the model parameters of an encoder model should trend to increasing the third set of similarity scores over multiple training iterations.

When determining a similarity, some embodiments may determine a vector or another type of first encoded representation in a latent space. The first encoded representation may represent the encoder model output for a full event data input that includes data from both restricted event streams and unrestricted event streams. Furthermore, some embodiments may determine a set of unrestricted encoded representations by filtering data provided by multiple event streams to remove one or more restricted events and then providing the filtered data to an encoder model. Some embodiments may then determine a set of distances in latent space between the first encoded representation and the set of unrestricted encoded representations. For example, some embodiments may determine a latent space distance using a cosine similarity function. Alternatively, some embodiments may determine a latent space distance as a Manhattan distance or Euclidean distance in the latent space.

As described elsewhere, some embodiments may compare a first encoded representation with a second encoded representation, where the first encoded representation is derived from data associated with a first user, and where the second encoded representation is derived from data associated with a second user. For example, some embodiments may generate a first complete encoded representation based on both restricted and unrestricted data associated with a first user and generate a second complete encoded representation based on both restricted and unrestricted data associated with a second user. Some embodiments may then determine a similarity value (e.g., a latent space distance) between the first and second complete encoded representations and use this similarity value to determine a contribution to a loss function value. For example, some embodiments use a loss function configured such that an increase in the similarity value between the first and second complete encoded representations may cause a decrease in the loss function value under a training regime in which loss functions trend to a greater value for each iteration.

Alternatively, or additionally, some embodiments may determine additional contributions to a loss function value based on unrestricted data associated with the second user. For example, after determining a first complete encoded representation associated with a first user, some embodiments may generate a second unrestricted encoded representation associated with a second user. To generate the second unrestricted encoded representation, some embodiments may input second unrestricted data provided by an unrestricted data stream into an encoder model without inputting second restricted data provided by a restricted data stream into the encoder model. In cases where a training operation trends toward increasing a loss function value, the loss function may be configured such that an increase in a similarity score between the first complete encoded representation and the second unrestricted encoded representation decreases the loss function value. For example, some embodiments may determine a latent space distance between the first encoded representation and a second encoded representation and use this distance to determine a loss function output.

Some embodiments may apply regularization techniques to prevent other types of data overfitting, such as L1/L2 regularization, dropout, and data augmentation. For example, with reference to FIG. 2, some embodiments may apply L2 regularization by modifying Equation 2 such that a sum of the squares of the weights of the encoder model 220 is added to the loss function value L. By applying such additional regularization techniques, some embodiments may prevent overfitting to a particular user.

Some embodiments may determine whether a set of training termination criteria is satisfied, as indicated by block 320. Some embodiments may apply a criterion involving a loss function threshold, where some embodiments may determine that the set of training termination criteria is satisfied if a loss function value satisfies the loss function threshold. For example, with reference to Equation 2 above, some embodiments may determine that the set of training termination criteria is satisfied based on a determination that L is greater than a threshold value. However, it should be understood that different formulations of the loss function value may result in a determination that the set of training termination criteria is satisfied based on a determination that L is less than a threshold value.

Alternatively, or additionally, some embodiments may apply a criterion involving a loss function change threshold, where some embodiments may determine that the set of training termination criteria is satisfied if the difference between loss function values across two or more iterations satisfies a loss function change threshold. For example, some embodiments may determine that the set of training termination criteria is satisfied based on a determination that a change between a current loss function value and the previous loss function value is less than a threshold value set to 0.01. Some embodiments may apply early stopping techniques during training based on a detected degradation in a loss function value with respect to previous loss function values. For example, some embodiments may apply the criteria that a continued degradation in a loss function value over three iterations results in a determination that the training termination criteria is satisfied. In some embodiments, the set of training termination criteria may include a maximum amount of training time, where a detection that a training time that exceeds the maximum amount of training time results in a determination that the set of training termination criteria is satisfied. If the set of training criteria is satisfied, operations of the process 300 may proceed to operations described for block 324. Otherwise, operations of the process 300 may proceed to block 304.

Some embodiments may generate a candidate encoded representation associated with using the trained encoder model, as indicated by block 324. After performing some or all of the operations of the process 300 to obtain a trained encoder model, some embodiments may use the trained encoder model to generate a candidate encoded representation based on input data provided to the trained encoder model. Some embodiments may then generate a database of encoded representations (e.g., vectors) based on different input data from multiple restricted and unrestricted data streams. Alternatively, or additionally, some embodiments may generate an encoded representation based on new data. For example, some embodiments may obtain first new data from a transaction data stream that is classified as an unrestricted data stream and obtain second new data from a clickstream data stream that is classified as a restricted data stream. Some embodiments may filter out the second new data for being clickstream data and then generate a candidate reference vector for the first user based on the second new data, where the candidate reference vector may be in the same embedding space as the restricted and unrestricted dense vectors used to train the trained encoder model. In some embodiments, the second new data may be appended to data representing a previous sequence of events associated with the user to generate updated data, where some embodiments may then provide the updated data to the trained encoder model to determine a candidate reference vector for the user.

Some embodiments may generate a predicted value based on the candidate encoded representation, as indicated by block 328. Some embodiments may be configured to automatically predict one or more values in response to receiving new events or in response to receiving new events that satisfy a set of criteria. Alternatively, some embodiments may receive a request to generate a prediction and perform operations to generate the prediction in response to receiving the request. For example, some embodiments may receive a request to generate a candidate reference vector for a first user based on an encoder model described in this disclosure, where the candidate reference vector may represent the first user.

To generate a predicted value, some embodiments may concatenate an encoded representation and provide the concatenated encoded representation to a prediction model. For example, some embodiments may generate a candidate reference vector for a user and then concatenate the numbers of the reference vector to determine a concatenated value (where one or more delimiters may be used to separate the numbers). Some embodiments may then provide the concatenated value to a prediction model. For example, some embodiments may provide the concatenated value to a trained neural network that then outputs a classification that can be used as an indicator. Some embodiments may generate or present a malicious activity indicator that indicates that a user is engaging in malicious activity. It should be understood that a prediction model may include a neural network model (e.g., a transformer neural network model, a CNN encoder model, etc.), another type of machine learning model (e.g., a random forest), a rules-based prediction system, a statistical model, etc.

Some embodiments may be configured to directly receive an encoded representation (e.g., a candidate reference vector representing an updated event sequence for a first user). For example, some embodiments may output a malicious activity indicator based on a candidate reference vector. In some embodiments, an indicator may be associated with a user record or transaction record to flag a user or transaction for further review. Alternatively, or additionally, some embodiments may suspend or stop a set of database transactions associated with a user that is associated with the candidate reference vector.

It should be understood that, while input data for an encoder model or an encoded representation generated by the encoder model may be described as being associated with the user, some embodiments may use input data or generate an encoded representation that is associated with a non-user entity, a group of users or other entities, an aggregation of a population, a data object, a file, etc. Furthermore, some embodiments may extend operations described in this disclosure to other types of data. For example, some embodiments may classify all tokens indicated to be user-identifying information as restricted data. For example, some embodiments may obtain a document that treats non-user-identifying information as data from an unrestricted event stream and treats the user-identifying information as restricted data from a restricted event stream. Some embodiments may then perform operations described in this disclosure to generate a candidate reference vector for the document and determine an indicator (e.g., an indicator of an anomalous document) based on the candidate reference vector.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIGS. 1-2 could be used to perform one or more of the operations described in relation to FIGS. 3-4.

It should be noted that the features and limitations described in any one embodiment may be applied to any other embodiment herein, and a flowchart or examples relating to one embodiment may be combined with any other embodiment in a suitable manner, done in different orders, or done in parallel. Furthermore, not all operations of a flowchart need to be performed. For example, some embodiments may perform operations of block 430 without performing operations of block 440. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:
1. A method comprising: generating a first complete encoded representation using an encoder model based on unrestricted data provided by a first unrestricted data stream and restricted data provided by a restricted data stream; generating an unrestricted encoded representation based on the first unrestricted data; evaluating a loss function value by updating the loss function value based on a similarity between the first complete encoded representation and the unrestricted encoded representation; and updating the encoder model based on the loss function value.
2. The method of embodiment 1, further comprising generating a second complete encoded representation based on second unrestricted data provided by a second unrestricted data stream, wherein updating the loss function value comprises updating encoder model based on a similarity between the first and second complete encoded representations.
3. The method of any of the embodiments above, further comprising generating an encoded representation by using the encoder model after the updating of the encoder model based on data from the first unrestricted data stream.
4. A method comprising: generating a first complete encoded representation by inputting, into an encoder model, first unrestricted data provided by a first unrestricted data stream and restricted data provided by a restricted data stream; generating a second complete encoded representation by inputting, into the encoder model, second unrestricted data provided by a second unrestricted data stream; generating an unrestricted encoded representation by inputting, into the encoder model, the first unrestricted data without inputting the restricted data into the encoder model to generate the unrestricted encoded representation; evaluating a loss function value by (1) updating the loss function value based on a similarity between the first complete encoded representation and the unrestricted encoded representation and (2) updating the loss function value based on a similarity between the first and second complete encoded representations; updating the encoder model based on the loss function value; generating an encoded representation by inputting, into the encoder model after the updating of the encoder model, filtered data comprising additional data from the first unrestricted data stream and not data from the restricted data stream; and generating an indicator based on the encoded representation.
5. A method comprising: generating a first complete dense vector for a first user by inputting, into an encoder model, first unrestricted data provided by a first unrestricted event stream and restricted data provided by a restricted event stream; generating a second complete dense vector for a second user by inputting, into the encoder model, second unrestricted data provided by a second unrestricted event stream; generating a unrestricted dense vector by inputting, into the encoder model, the first unrestricted data without inputting the restricted data into the encoder model to generate the unrestricted dense vector; evaluating a loss function value by (i) increasing the loss function value based on a first similarity between the first complete dense vector and the unrestricted dense vector and (ii) decreasing the loss function value based on a second similarity between the first complete dense vector for the first user and the second complete dense vector for the second user; updating the encoder model by backpropagating the loss function value to update weights of the encoder model; generating a candidate reference vector mapped to the first user by inputting, into the encoder model after the updating of the weights, filtered data comprising new events from the first unrestricted event stream without data from the restricted event stream; and generating a malicious activity indicator by providing the candidate reference vector to a prediction model.
6. A method comprising: generating a first complete encoded representation by inputting, into an encoder model, first unrestricted data provided by a first unrestricted event stream and restricted data provided by a restricted event stream; generating a second complete encoded representation by inputting, into the encoder model, second unrestricted data provided by a second unrestricted event stream; generating an unrestricted encoded representation by inputting, into the encoder model, the first unrestricted data without inputting the restricted data into the encoder model to generate the unrestricted encoded representation; evaluating a loss function value by (i) increasing the loss function value based on a first similarity between the first complete encoded representation and the unrestricted encoded representation and (ii) decreasing the loss function value based on a second similarity between the first complete encoded representation and the second complete encoded representation; updating weights of the encoder model based on the loss function value; generating a candidate encoded representation by inputting, into the encoder model after the updating of the weights, filtered data comprising additional data from the first unrestricted event stream without data from the restricted event stream; and generating an indicator by providing the candidate encoded representation to a prediction model.
7. The method of any of the embodiments above, wherein the restricted data is first restricted data, wherein the restricted event stream is a first restricted event stream, further comprising: obtaining second restricted data provided by a second restricted event stream, wherein inputting the second unrestricted data into the encoder model comprises inputting the second unrestricted data and the second restricted data into the encoder model; generating a second unrestricted encoded representation by inputting, into the encoder model, the second unrestricted data without inputting the second restricted data into the encoder model to generate the second unrestricted encoded representation; and decreasing the loss function value based on a similarity between the first complete encoded representation and the second unrestricted encoded representation.
8. The method of any of the embodiments above, wherein generating the first complete encoded representation comprises randomly selecting a portion of broader data for use as the first unrestricted data.
9. The method of embodiment 8, further comprising selecting event data provided by the restricted event stream within a time range defined by the randomly selected portion for use as the restricted data.
10. The method of any of the embodiments above, further comprising determining the first similarity based on a latent space distance between the first complete encoded representation and the unrestricted encoded representation, wherein increasing the loss function value comprises increasing the loss function value based on the latent space distance.
11. The method of any of the embodiments above, further comprising determining the second similarity between the first complete encoded representation and the second complete encoded representation based on a latent space distance between the first complete encoded representation and the second complete encoded representation, wherein decreasing the loss function value based on the second similarity between the first complete encoded representation and the second complete encoded representation comprises decreasing the loss function value based on the latent space distance.
12. The method of any of the embodiments above, further comprising: obtaining data from plurality of event streams comprising the first unrestricted event stream and the restricted event stream; and determining that a candidate event stream of the plurality of event streams is the restricted event stream based on an identifier stored in a record provided by the candidate event stream.
13. The method of any of the embodiments above, wherein the encoded representation is a first encoded representation, further comprising: storing the first encoded representation in a database in association with a first user; generating a second encoded representation by inputting, into the encoder model, filtered data comprising the additional data and data from the restricted data; storing the second encoded representation in the database in association with the first user; and obtaining a request identifying the first user, wherein the request comprises an indicator of a request source, wherein providing the first encoded representation to the prediction model comprises selecting the first encoded representation in lieu of the second encoded representation to provide to the prediction model based on the indicator of the request source.
14. The method of any of the embodiments above, wherein: the unrestricted encoded representation is a first unrestricted encoded representation, the restricted event stream is a second restricted event stream, the loss function value is a first loss function value, the candidate encoded representation is a first encoded representation, further comprising: generating the first complete encoded representation comprises inputting, into the encoder model, second restricted data provided by the second restricted event stream; generating the first unrestricted encoded representation comprises inputting, into the encoder model, the second restricted data; generating a second unrestricted encoded representation by inputting, into the encoder model, the first unrestricted data and the second unrestricted data without inputting the second restricted data; increasing a second loss function value based on a similarity between the first complete encoded representation and the second unrestricted encoded representation; determining second weights for the encoder model by updating the encoder model based on the second loss function value; and generating a second encoded representation by inputting, into the encoder model configured with the second weights, filtered data comprising additional data from the first unrestricted event stream and without data from the second restricted data.
15. The method of embodiment 14, further comprising obtaining a query indicating a user associated with the first unrestricted event stream, wherein the query in association with a user account, wherein generating the indicator comprises selecting the first encoded representation in lieu of the second encoded representation based on an identifier associated with the query.
16. A method comprising: generating a first complete encoded representation by inputting, into an encoder model, first unrestricted data provided by a first unrestricted data stream and restricted data provided by a restricted data stream; generating a second complete encoded representation by inputting, into the encoder model, second unrestricted data provided by a second unrestricted data stream; generating an unrestricted encoded representation by inputting, into the encoder model, the first unrestricted data without inputting the restricted data into the encoder model to generate the unrestricted encoded representation; evaluating a loss function value by (1) updating the loss function value based on a similarity between the first complete encoded representation and the unrestricted encoded representation and (2) updating the loss function value based on a similarity between the first and second complete encoded representations; updating the encoder model based on the loss function value; generating an encoded representation by inputting, into the encoder model after the updating of the encoder model, filtered data comprising additional data from the first unrestricted data stream and not data from the restricted data stream; and generating an indicator based on the encoded representation.
17. The method of any of the embodiments above, wherein the restricted data is first restricted data, wherein the restricted data stream is a first restricted data stream, the operations further comprising: obtaining second restricted data provided by a second restricted data stream, wherein inputting the second unrestricted data into the encoder model comprises inputting the second unrestricted data and the second restricted data into the encoder model; generating a second unrestricted encoded representation by inputting, into the encoder model, the second unrestricted data without inputting the second restricted data into the encoder model to generate the second unrestricted encoded representation; and updating the loss function value based on a similarity between the first complete encoded representation and the second unrestricted encoded representation.
18. The method of any of the embodiments above, the operations further comprising obtaining a request identifying a first user associated with the first unrestricted data stream, wherein: the request is associated with an indicator of a request source, and inputting filtered data into the encoder model comprises determining that the filtered data should not comprise the data from the restricted data stream based on the indicator of the request source.
19. The method of any of the embodiments above, the operations further comprising determining the similarity between the first complete encoded representation and the unrestricted encoded representation by computing a cosine similarity between the first complete encoded representation and the unrestricted encoded representation.
20. The method of any of the embodiments above, wherein generating the indicator based on the encoded representation comprises providing the encoded representation to a transformer neural network model.
21. The method of any of the embodiments above, further comprising: determining that a candidate data stream comprises a first identifier; and assigning the candidate data stream as the restricted data stream based on a detected match between the first identifier and a target identifier indicated in a database.
22. The method of any of the embodiments above, further comprising filtering a broader data provided by the first unrestricted data stream with a set of filter criteria to determine the first unrestricted data.
23. The method of any of the embodiments above, the operations further comprising: randomly selecting a portion of broader data comprising the first unrestricted data and the restricted data; and determining at least one of the first unrestricted data or the restricted data based on the randomly selected portion.
24. The method of any of the embodiments above, wherein the restricted data stream indicates user interactions with a web application.
25. One or more tangible, non-transitory, machine-readable media storing instructions that, when executed by a set of processors, cause the set of processors to effectuate operations comprising those of any of embodiments 1 to 24.
26. A system comprising: a set of processors and a set of media storing computer program instructions that, when executed by the set of processors, cause the set of processors to effectuate operations comprising those of any of embodiments 1 to 24.

What is claimed is:

1. A system for generating dense vector representations of users based on filtered event stream data to detect malicious activity, the system comprising one or more memory devices programmed with instructions that, when executed by one or more processors, cause operations comprising:
generating a first complete dense vector for a first user by inputting, into an encoder model, first unrestricted data provided by a first unrestricted event stream and restricted data provided by a restricted event stream;
generating a second complete dense vector for a second user by inputting, into the encoder model, second unrestricted data provided by a second unrestricted event stream;
generating a unrestricted dense vector by inputting, into the encoder model, the first unrestricted data without inputting the restricted data into the encoder model to generate the unrestricted dense vector;
evaluating a loss function value by (i) increasing the loss function value based on a first similarity between the first complete dense vector and the unrestricted dense vector and (ii) decreasing the loss function value based on a second similarity between the first complete dense vector for the first user and the second complete dense vector for the second user;
updating the encoder model by backpropagating the loss function value to update weights of the encoder model;
generating a candidate reference vector mapped to the first user by inputting, into the encoder model after the updating of the weights, filtered data comprising new events from the first unrestricted event stream without data from the restricted event stream; and
generating a malicious activity indicator by providing the candidate reference vector to a prediction model.

2. A method comprising:
generating a first complete encoded representation by inputting, into an encoder model, first unrestricted data provided by a first unrestricted event stream and restricted data provided by a restricted event stream;
generating a second complete encoded representation by inputting, into the encoder model, second unrestricted data provided by a second unrestricted event stream;
generating an unrestricted encoded representation by inputting, into the encoder model, the first unrestricted data without inputting the restricted data into the encoder model to generate the unrestricted encoded representation;
evaluating a loss function value by (i) increasing the loss function value based on a first similarity between the first complete encoded representation and the unrestricted encoded representation and (ii) decreasing the loss function value based on a second similarity between the first complete encoded representation and the second complete encoded representation;
updating weights of the encoder model based on the loss function value;
generating a candidate encoded representation by inputting, into the encoder model after the updating of the weights, filtered data comprising additional data from the first unrestricted event stream without data from the restricted event stream; and
generating an indicator by providing the candidate encoded representation to a prediction model.

3. The method of claim 2, wherein the restricted data is first restricted data, wherein the restricted event stream is a first restricted event stream, further comprising:
obtaining second restricted data provided by a second restricted event stream, wherein inputting the second unrestricted data into the encoder model comprises inputting the second unrestricted data and the second restricted data into the encoder model;
generating a second unrestricted encoded representation by inputting, into the encoder model, the second unrestricted data without inputting the second restricted data into the encoder model to generate the second unrestricted encoded representation; and
decreasing the loss function value based on a similarity between the first complete encoded representation and the second unrestricted encoded representation.

4. The method of claim 2, wherein generating the first complete encoded representation comprises randomly selecting a portion of broader data for use as the first unrestricted data.

5. The method of claim 4, further comprising selecting event data provided by the restricted event stream within a time range defined by the randomly selected portion for use as the restricted data.

6. The method of claim 2, further comprising determining the first similarity based on a latent space distance between the first complete encoded representation and the unrestricted encoded representation, wherein increasing the loss function value comprises increasing the loss function value based on the latent space distance.

7. The method of claim 2, further comprising determining the second similarity between the first complete encoded representation and the second complete encoded representation based on a latent space distance between the first complete encoded representation and the second complete encoded representation, wherein decreasing the loss function value based on the second similarity between the first complete encoded representation and the second complete encoded representation comprises decreasing the loss function value based on the latent space distance.

8. The method of claim 2, further comprising:
obtaining data from plurality of event streams comprising the first unrestricted event stream and the restricted event stream; and
determining that a candidate event stream of the plurality of event streams is the restricted event stream based on an identifier stored in a record provided by the candidate event stream.

9. The method of claim 2, wherein the encoded representation is a first encoded representation, further comprising:
storing the first encoded representation in a database in association with a first user;
generating a second encoded representation by inputting, into the encoder model, filtered data comprising the additional data and data from the restricted data;
storing the second encoded representation in the database in association with the first user; and
obtaining a request identifying the first user, wherein the request comprises an indicator of a request source, wherein providing the first encoded representation to the prediction model comprises selecting the first encoded representation in lieu of the second encoded representation to provide to the prediction model based on the indicator of the request source.

10. The method of claim 2, wherein:
the unrestricted encoded representation is a first unrestricted encoded representation,
the restricted event stream is a second restricted event stream,
the loss function value is a first loss function value,
the candidate encoded representation is a first encoded representation,
further comprising:
generating the first complete encoded representation comprises inputting, into the encoder model, second restricted data provided by the second restricted event stream;
generating the first unrestricted encoded representation comprises inputting, into the encoder model, the second restricted data;
generating a second unrestricted encoded representation by inputting, into the encoder model, the first unrestricted data and the second unrestricted data without inputting the second restricted data;
increasing a second loss function value based on a similarity between the first complete encoded representation and the second unrestricted encoded representation;
determining second weights for the encoder model by updating the encoder model based on the second loss function value; and
generating a second encoded representation by inputting, into the encoder model configured with the second weights, filtered data comprising additional data from the first unrestricted event stream and without data from the second restricted data.

11. The method of claim 9, further comprising obtaining a query indicating a user associated with the first unrestricted event stream, wherein the query in association with a user account, wherein generating the indicator comprises selecting the first encoded representation in lieu of the second encoded representation based on an identifier associated with the query.

12. One or more non-transitory, machine-readable media comprising program instructions that, when executed by one or more processors, performs operations comprising:
generating a first complete encoded representation by inputting, into an encoder model, first unrestricted data provided by a first unrestricted data stream and restricted data provided by a restricted data stream;
generating a second complete encoded representation by inputting, into the encoder model, second unrestricted data provided by a second unrestricted data stream;
generating an unrestricted encoded representation by inputting, into the encoder model, the first unrestricted data without inputting the restricted data into the encoder model to generate the unrestricted encoded representation;
evaluating a loss function value by (1) updating the loss function value based on a similarity between the first complete encoded representation and the unrestricted encoded representation and (2) updating the loss function value based on a similarity between the first and second complete encoded representations;
updating the encoder model based on the loss function value;
generating an encoded representation by inputting, into the encoder model after the updating of the encoder model, filtered data comprising additional data from the first unrestricted data stream and not data from the restricted data stream; and
generating an indicator based on the encoded representation.

13. The one or more non-transitory, machine-readable media of claim 12, wherein the restricted data is first restricted data, wherein the restricted data stream is a first restricted data stream, the operations further comprising:
obtaining second restricted data provided by a second restricted data stream, wherein inputting the second unrestricted data into the encoder model comprises inputting the second unrestricted data and the second restricted data into the encoder model;
generating a second unrestricted encoded representation by inputting, into the encoder model, the second unrestricted data without inputting the second restricted data into the encoder model to generate the second unrestricted encoded representation; and
updating the loss function value based on a similarity between the first complete encoded representation and the second unrestricted encoded representation.

14. The one or more non-transitory, machine-readable media of claim 12, the operations further comprising obtaining a request identifying a first user associated with the first unrestricted data stream, wherein:
the request is associated with an indicator of a request source, and
inputting filtered data into the encoder model comprises determining that the filtered data should not comprise the data from the restricted data stream based on the indicator of the request source.

15. The one or more non-transitory, machine-readable media of claim 12, the operations further comprising determining the similarity between the first complete encoded representation and the unrestricted encoded representation by computing a cosine similarity between the first complete encoded representation and the unrestricted encoded representation.

16. The one or more non-transitory, machine-readable media of claim 12, wherein generating the indicator based on the encoded representation comprises providing the encoded representation to a transformer neural network model.

17. The one or more non-transitory, machine-readable media of claim 12, further comprising:
determining that a candidate data stream comprises a first identifier; and
assigning the candidate data stream as the restricted data stream based on a detected match between the first identifier and a target identifier indicated in a database.

18. The one or more non-transitory, machine-readable media of claim 12, further comprising filtering a broader data provided by the first unrestricted data stream with a set of filter criteria to determine the first unrestricted data.

19. The one or more non-transitory, machine-readable media of claim 12, the operations further comprising:
randomly selecting a portion of broader data comprising the first unrestricted data and the restricted data; and
determining at least one of the first unrestricted data or the restricted data based on the randomly selected portion.

20. The one or more non-transitory, machine-readable media of claim 12, wherein the restricted data stream indicates user interactions with a web application.
